(19) United States
(12) Patent Application Publication
(10) Pub. No.: US 2026/0237649 A1
(43) Pub. Date: Aug. 13, 2026

(54) SOLID-PHASE METHOD FOR THE MANUFACTURE OF A CATHODE ACTIVE MATERIAL

(71) Applicant: Virginia Tech Intellectual Properties, Inc., Blacksburg, VA (US)

(72) Inventors: Feng Lin, Christiansburg, VA (US); Chenguang Shi, Blacksburg, VA (US)

(21) Appl. No.: 19/537,804

(22) Filed: Feb. 12, 2026

Related U.S. Application Data
(60) Provisional application No. 63/758,028, filed on Feb. 13, 2025.

(51) Int. Cl. H01M 4/505; C01B 25/45; C01G 49/00; C01G 53/51; H01M 4/58

(52) U.S. Cl. CPC H01M 4/505; C01B 25/45; C01G 49/0072; C01G 53/51; H01M 4/5825; C01P 2002/72; C01P 2002/85; C01P 2002/88; C01P 2004/03; C01P 2004/04; C01P 2006/40

(57) ABSTRACT

A solid-phase method for the manufacture of a cathode active material includes combining a metallic feedstock with an alkali metal source to form a reaction mixture. The metallic feedstock includes elemental transition metals. The method further includes heating the reaction mixture to induce oxidation of the metallic feedstock and provide a calcined mixture, and forming the cathode active material from the calcined mixture. The method simplifies the typical process by which cathode active materials are made, directly using metal or alloy starting materials to provide cathode active material with improved electrochemical properties. Electrochemical cells including the cathode active materials described herein are also described.

### CROSS REFERENCE TO RELATED APPLICATIONS

This application claims priority to U.S. Provisional Patent Application No. 63/758,028, filed Feb. 13, 2025, the contents of which are hereby incorporated by reference in their entirety.

### BACKGROUND

Electrochemical energy storage is increasingly constrained not only by materials performance but also by manufacturability and the resilience of upstream supply chains. For intercalation cathodes, the prevailing synthesis practice relies on wet-chemical routes, most commonly co-precipitated hydroxide or carbonate precursors followed by high-temperature calcination. While these approaches provide good compositional uniformity, they do so at the cost of process complexity, substantial wastewater generation, and frequent reliance on ammonia-based chemistries. Moreover, for cathode phases containing volatile alkali species, prolonged high-temperature treatments complicate phase control, as small variations in alkali retention can strongly perturb transition-metal (TM) valence states and defect chemistry, ultimately degrading electrochemical properties.

Accordingly, it would be advantageous to provide improved methods for the manufacture of alkali-ion cathode active materials (CAMs).

### SUMMARY

An aspect of the present disclosure is a solid-phase method for the manufacture of a cathode active material, the method comprising: combining a metallic feedstock comprising elemental metal particles with an alkali metal source to form a reaction mixture; heating the reaction mixture under conditions effective to induce oxidation of the metallic feedstock and provide a calcined mixture; and forming the cathode active material from the calcined mixture.

Another aspect is a cathode active material made by the method described herein.

Another aspect is an electrochemical cell comprising a cathode active material made by the present method.

The above described and other features are exemplified by the following figures and detailed description.

### BRIEF DESCRIPTION OF THE DRAWINGS

The following figures are exemplary embodiments.

FIG. 1 shows EDS maps after ball-milling showing micron-scale co-location of iron (Fe), manganese (Mn), sodium (Na) and oxygen (O).

FIG. 2 shows a bright-field transmission electron microscopy (TEM) image of a cathode active material sample according to an aspect of the disclosure before calcination with FFT from the boxed regions (I-V), indicating coexistence of intermediates together with nanoscale layered domains.

FIG. 3 shows 2D TXM of Mn K-edge position (whiteline position) across individual particles, with a color bar in eV.

FIG. 4 shows differential scanning calorimetry (DSC) (left axis) and TG (right axis) showing events coincident with mass loss, and shaded regions highlight three exotherms assigned to metal oxidation.

FIG. 5 shows in-situ XRD contour map collected during heating from room temperature to 400° C. for FM 13-M, showing layered peaks appear at 189° C., followed by peak sharpening on further heating.

FIG. 6 shows temperature-dependent Mn and Fe oxidation states fitted from the XANES spectra during the same heating sequence.

FIG. 7 shows Mn L-edge soft XAS of the ball-milled precursor (FM13-M-BM) and the 900° C. products (FM13-M-900), with Mn₂O₃ and MnO₂ reference spectra for comparison.

FIG. 8 shows Mn K-edge XANES spectra of FM13-M-900 and FM13-O-900, indicating a lower Mn valence and more Na incorporation in the former.

FIG. 9 shows powder XRD scan of FM13-M-900, with refinement results showing a typical P2 layered structure.

FIG. 10 shows SEM image of FM13-M-900 shows dense secondary particles.

FIG. 11 shows HAADF-STEM reveals lattice fringes with d≈0.251 nm viewed along.

FIG. 12 shows 3D reconstruction TXM map of FM13-M-900, together with internal electronic structure features revealed by a series of cross-sectional slices, based on the Mn K-edge white-line position with the color scale in eV.

FIG. 13 shows charging and discharging curves of initial cycles of FM13-M-900 and FM 13-O-900 at 0.1 C (1 C=130 mA g⁻¹) within 1.5-4.0 V, with a cathode active mass loading of ~5 mg cm⁻².

FIG. 14 shows long-term cycling durability of FM13-M-900 and FM13-O-900 at 0.5C within 1.5-4.0 V, with the initial three formation cycles at 0.1 C.

FIG. 15 shows rate capability over stepwise current increases, followed by capacity recovery upon returning to the initial current within 1.5-4.0 V.

FIG. 16 shows full-cell cycling durability of FM13-M-900 and FM13-O-900 paired with hard carbon at 0.5 C within 1.5-4.0 V, as well as the initial three formation cycles at 0.1 C, with a cathode active mass loading of ~8.5 mg cm⁻².

FIG. 17 shows XRD peak ratio to track the formation of the layered O3/P3 phase for samples prepared with different precursor routes and Na sources, where the ratio is defined as the intensity of a characteristic layered (003) peak area normalized to the most intense precursor peak (Mn metal or Mn₂O₃) area. Notably, beta-NaFeO₂ was detected as an intermediate phase in the NaOH scenario, and its presence is associated with fluctuations in the apparent layered content and, consequently, in the peak ratio.

FIG. 18 shows in-situ heating XRD patterns of FM13-M-OH collected during a low-temperature ramp from room temperature to 618° C., with ramp profile shown on the right side.

FIG. 19 shows powder XRD patterns of FM13-M-NaOH calcined at 500° C. and 700° C.

FIG. 20 shows cycling durability at 0.5 C (1 C=130 mA g⁻¹) within the voltage range of 1.5-4.0 V of the low-temperature products synthesized from metals using NaOH as the Na source, as well as the initial two formation cycles at 0.1 C.

FIG. 21 shows representative cycling data demonstrating that the metal-precursor route generalizes to additional alkali-ion cathode chemistries with promising electrochemical properties.

FIG. 22 shows powder XRD pattern and crystal-structure schematic of a LiFe_{0.6}Mn_{0.4}PO₄ cathode synthesized from metal precursors by a solid-state route.

### DETAILED DESCRIPTION

Sodium layered oxides offer a useful lens for the aforementioned manufacturing sensitivities. Prismatic (P)-type NaₓTMO₂ frameworks are attractive cathodes because they rely on earth-abundant elements and enable fast two-dimensional Na⁺ transport. However, the common P2 and P3 phases are synthetically sensitive. Sodium volatilization and kinetic competition among layered polymorphs, often accompanied by spinel-like or rocksalt-like motifs during calcination, can shift Na stoichiometry and stacking order. Such synthesis-induced variations directly alter TM redox, oxygen activity, which in turn controls long-term electrochemical reversibility.

An alternative manufacturing logic is to replace complex precursor engineering with more reactive metallic feedstocks that offer high chemical potential for accelerating reaction kinetics, broader compositional tunability, and a simpler alternative supply chain. Metal oxidation is strongly exothermic and can generate non-equilibrium intermediate states that are not accessible to conventional oxidized precursors, such as hydroxides and oxides. When oxidation occurs in the presence of alkali sources, the evolving intermediates incorporate alkali and oxygen as the CAM framework develops. Continuous oxidation upon thermal treatment then drives structural ordering between alkali ions and TM cations, leading to continuous CAM crystallization and growth. Together, these effects establish a distinct nucleation and growth pathway that allows phase and stoichiometry to be controlled through a simple all-dry process.

The present inventors have shown that the high reactivity of metallic precursors can be harnessed to enable controlled formation of intercalation CAMs, including sodium-and lithium-based layered and polyanion variants. In such a metal-accelerated solid-state synthesis, mechanochemical milling creates intimate contact between metals and alkali sources and allows for initial alkali insertion (e.g., sodiation or lithiation). Subsequent heating triggers exothermic oxidation that accelerates localized reaction kinetics. Using a Na—Fe—Mn—O layered CAM as a model, the layered nucleation was found to occur at unexpectedly low temperatures and that continuous oxidation during calcination reshapes the balance between phase formation and alkali stoichiometry, thereby broadening the processing window for phase and microstructure control. This lower-temperature, accelerated process yields CAMs with higher tap density and larger crystallites than conventional, high-temperature, slow synthesis routes, while simultaneously enhancing electrochemical kinetics and cycling durability. A significant improvement is therefore provided by the present disclosure.

Accordingly, an aspect of the disclosure is a solid-phase method for the manufacture of a cathode active material. Advantageously, the presently disclosed method addresses technical challenges associated with conventional methods by directly using elemental metals or alloys to provide high performance cathode active materials. By eliminating intermediary steps, such as the formation of metal oxides and sulfates, the present method can streamline the production process. The present inventors discovered that during the process disclosed herein, transition metals can be converted into high oxidation states, facilitating the formation of layered phases. This process yields dense, phase-pure cathode particles with improved electrochemical kinetics and durability and establishes a scalable, all-dry route for energy-and process-efficient battery materials manufacturing. The broad accessibility of metals, obtained either through mechanochemical metals or from commercially available new or recycled sources, enables a wide and tunable compositional space for synthesizing layered and polyanion CAMs.

The method comprises combining a metallic feedstock with an alkali metal source to form a reaction mixture. The metallic feedstock comprises elemental metal, for example in the form of particles. In some aspects, the elemental metal can comprise a transition metal. The metallic feedstock can comprise, for example, wherein the metallic feedstock comprises iron, manganese, nickel, cobalt, titanium, chromium, copper, zinc, tungsten, aluminum, magnesium, zirconium, germanium, molybdenum, tin, niobium, lanthanum, tantalum, calcium, vanadium, or a combination thereof, for example iron, manganese, nickel, cobalt, lithium, titanium, or a combination thereof. In an aspect, specific combinations of elemental transition metals can include, but are not limited to, iron and manganese; iron, manganese and titanium; nickel and manganese; or nickel, iron and manganese. When more than one transition metal is present in the feedstock, the molar ratios of each metal can be selected based on the desired stoichiometry for the cathode active material product.

The metallic feedstock can comprise new, recycled, or reclaimed metallic material. In some aspects, the metallic feedstock can comprise recycled or reclaimed metal material. Such recycled materials may contain additional elements or alloying constituents such as those present in stainless steels or other commercial metal mixtures. The presence of these incidental elements does not preclude effective formation of the desired cathode active materials by the solid-phase metal-precursor pathway described herein. Rather, the process tolerates typical impurities found in recycled feedstocks while still enabling controlled oxidation, alkali incorporation, and layered or polyanion framework formation.

Advantageously, the metallic feedstock does not comprise an oxidized metallic precursor. Stated another way, no oxidized metallic precursors (e.g., transition metal oxides or hydroxides such as iron oxide, manganese oxide, or the like) are intentionally added to the metallic feedstock. It is recognized, however, that metallic powders and particulates can undergo minor, naturally occurring surface oxidation when exposed to ambient air during storage, handling, or transfer. Accordingly, in some aspects, the metallic feedstock may include metal particles which are partially oxidized (e.g., at least a portion of a surface of the metal particles may include thin, incidental oxide films on at least a portion of their surfaces). The partial oxidation may be from exposure of the metallic feedstock to ambient air. However the present method does not include a step to intentionally oxidize the metallic feedstock with the intent of providing an oxidized metallic precursor. Stated another way, no deliberate oxidation (e.g., thermal, chemical, electrochemical, or otherwise) is performed to convert the metallic feedstock into an oxidized form. Any oxidation present in the metallic feedstock of the present disclosure is a consequence of environmental exposure and is not indicative of the addition of an oxidized precursor material.

The alkali metal source comprises an alkali metal carbonate, an alkali metal hydroxide, an alkali metal peroxide, or a combination thereof. The alkali metal can be lithium, sodium, potassium, or a combination thereof. Exemplary alkali metal sources can include, for example, sodium carbonate, sodium hydroxide, lithium carbonate, lithium hydroxide, potassium carbonate, potassium hydroxide, or a combination thereof.

The alkali metal source can be used in an effective amount to provide a desired stoichiometry of the alkali metal in the cathode active material. In some aspects, a molar excess relative to the metallic feedstock can be used, for example at least a 1 mole percent excess, or a 5 mole percent excess, or a 10 mole percent excess, or a 20 mole percent excess of the alkali metal source can be used.

The metallic feedstock and the alkali metal source are combined to form a reaction mixture. Combining the metallic feedstock with the alkali metal source can be by various methods of mechanochemical mixing. In an aspect, the combining can comprise ball milling, planetary milling, or mixer milling, preferably ball milling. The mixing can be performed for any suitable time, for example 5 to 12 hours, or 6 to 10 hours. The combining (e.g., milling) can be in a dry or inert atmosphere. For example, the combining (e.g., milling) may take place in an argon or nitrogen atmosphere. Typically, the ball size is selected by the person of ordinary skill to obtain the desired particle size.

The reaction mixture is subsequently heated under conditions effective to induce oxidation of the reaction mixture and provide a calcined mixture. Heating the reaction mixture can also be referred to herein as “calcining the mixture” or a “calcination step”. Heating or calcining the reaction mixture can be at, for example, a temperature of less than or equal to 900° C., for example 400 to 900° C., and for a time of 12 hours or less. Heating or calcining the reaction mixture can be in the presence of oxygen, for example in air or with flowing oxygen. In an advantageous feature, onset alkali metal insertion can occur at a temperature of 500° C. or less, for example 400° C. or less.

The heating rate can be, for example, 0.5 to 10° C./min, or 1 to 10° C./min, or 2 to 10° C./min, or 3 to 10° C./min, or 4 to 10° C./min, or 5 to 10° C./min, or 6 to 10° C./min, or 7 to 10° C./min, or 8 to 10° C./min, or 9 to 10° C./min.

The calcined mixture is formed into the cathode active material. Forming the cathode active material can include cooling the calcined mixture, for example to a temperature of 20 to 30° C., or about 25° C. Optionally, the cooled calcined mixture can be crushed or milled to provide cathode active material particles having a desired size.

The resulting cathode active material can be a layered cathode active material, also referred to as an alkali-ion layered cathode active material. Layered alkali-metal transition-metal oxides described herein may adopt multiple crystallographic stacking types depending on composition, alkali-metal stoichiometry, thermal history, and the like. As shown in the present disclosure, the use of elemental metallic precursors can generate distinct reaction intermediates and early ordering phenomena that promote the formation of layered frameworks at unusually low temperatures, including the appearance of P2- and P3-type features during initial oxidation and alkali metal insertion. These layered polymorphs differ in the relative arrangement of MO₂ slabs and the coordination geometry of the interlayer alkali-metal ions, features which strongly influence ion transport, redox behavior, and long-term cycling stability. The structural descriptors “P2,” “P3,” “O3,” and the like therefore provide a concise means of distinguishing among these crystallographically related but electrochemically distinct frameworks and are used herein to describe both idealized structures and their non-ideal or mixed-phase variants, including those formed transiently during heating, intermediate phase evolution, or pathway-dependent crystallization.

Thus, in some aspects, the cathode active material can be a P2, P3, or O3 layered material. As used herein, the terms “P2,” “P3,” “O3,” and related structural designations refer to the crystallographic notation commonly used for alkali-metal layered transition-metal oxides according to the Delmas classification system. In this notation, the letter indicates the coordination environment of the interlayer alkali-metal ions, wherein “P” denotes trigonal prismatic coordination and “O” denotes octahedral coordination. The numeral following the letter denotes the number of MO₂ (M=transition metal) slabs per repeating unit along the crystallographic stacking direction. Thus, a P2 structure comprises alkali-metal ions occupying trigonal prismatic sites between two MO₂ slabs per repeat unit, typically associated with an ABBA-type oxygen stacking sequence. A P3 structure comprises alkali-metal ions in trigonal prismatic sites between three MO₂ slabs per repeat unit, generally corresponding to an ABCABC-type oxygen stacking sequence. An O3 structure comprises alkali-metal ions in octahedral sites between three MO₂ slabs per repeat unit, also exhibiting an ABCABC-type oxygen stacking sequence. Unless otherwise specified, these structural designations are intended to encompass ideal, non-ideal, partially ordered, mixed-phase, and defect-containing variants of the corresponding layered frameworks.

Mixed layered structures are also contemplated by the present disclosure, where layered alkali-metal transition-metal oxide frameworks can exhibit coexisting or intergrown crystallographic stacking motifs corresponding to more than one Delmas-type structural designation. Such mixed structures may arise when the material contains regions, domains, or stacking sequences characteristic of both P-type and O-type coordination environments and/or differing numbers of MO2 slabs per repeating unit. For example, a mixed P2/P3 structure contains interlayer alkali-metal sites that locally assume trigonal prismatic coordination, but with two-slab (P2) and three-slab (P3) stacking sequences present within the same particle or crystallite. Similarly, a mixed O3/P3 structure denotes a material exhibiting octahedrally coordinated alkali-metal sites characteristic of O3 ordering in combination with P3-type trigonal prismatic coordination or stacking faults associated with P3 sequences. These mixed or faulted layered arrangements may result from pathway-dependent crystallization, early nucleation phenomena, alkali-metal nonstoichiometry, temperature-dependent phase evolution, or incomplete transformation between ideal P-type and O-type frameworks.

In a specific aspect, the cathode active material can comprise a P2-type Na_{0.7}Fe_{0.25} Mn_{0.75}O₂ layered cathode active material; or a P2-type NaₓFe_{0.25}Mn_{0.75}T_{0.10}O₂ layered cathode active material; or a P2-type NaₓNi_{0.25}Mn_{0.75}O₂ layered cathode active material, where 0<x<1; or a lithium nickel oxide layered cathode active material; or an O3-type NaNi_{1/3}Fe_{1/3}Mn_{1/3}O₂ layered cathode active material; or a LiFe_{0.6}Mn_{0.4}PO₄ olivine cathode active material.

The cathode active material made by the method of the present disclosure can exhibit one or more advantageous properties. The presently disclosed method can yield a cathode active material having a dense secondary particulate structure, such that the cathode active material has a packing density that is at least 15% greater than a packing density of a corresponding cathode active material prepared from a metal oxide precursor. The cathode active material of the present disclosure can also exhibit one or more improved electrochemical properties relative to a corresponding cathode active material that is prepared from metal oxide precursors. For example, the cathode active material can exhibit a capacity that is greater than that of a corresponding cathode active material prepared from a metal oxide precursor, determined at a voltage of 1.5-4.0 V and a rate of 0.1 C. The cathode active material can also exhibit a capacity retention of at least 85%, or at least 90% after 100 cycles, or after 120 cycles, or after 140 cycles at a rate of 0.5 C. Additional technical advantages will be apparent from the working examples provided herein.

The cathode active material provided by the method described herein is particularly well suited for use in an electrochemical cell or a battery. Accordingly, an electrochemical cell represents another aspect of the present disclosure. The electrochemical cell comprises the cathode active material. In an aspect, the electrochemical cell comprises a cathode comprising the cathode active material, an anode, and a separator disposed between the cathode and the anode. The electrochemical cell can be a lithium-ion battery, a sodium-ion battery, or a potassium-ion battery. Advantageously, the electrochemical cells and batteries disclosed herein can have larger capacities, longer cycling times, and better ability to retain energy density over multiple charge cycles than electrochemical cells or batteries including cathode active materials not made by the presently disclosed method.

The cathode can be prepared, for example, by dispersing the cathode active material and optionally a binder in a suitable solvent to form a slurry, casting the slurry onto a cathodic current collector, and evaporating the solvent to form the cathode. Suitable solvents can be selected by one skilled in the art guided by the present disclosure. For example, the solvent may be a polar organic solvent such as N-methyl-2-pyrrolidone, or may be an aqueous solvent such as water. The current collector can comprise, for example, a metal foil such as an aluminum foil.

The binder, when present, is not particularly limited and can be a thermoplastic polymer. For example, the binder can comprise a fluoropolymer, a styrene-butadiene rubber, ethylene vinyl acetate, an acrylic polymer or copolymer, a polyurethane, a styrenic polymer, a polyamide, a polyester, a polyvinyl chloride, a polycarbonate, a polyolefin, polyvinylpyrrolidone, polymethylmethacrylate, polyacrylic acid, polyacrylonitrile, polypyrrole, styrene-acrylonitrile, polyacrylamide, polyvinyldichloride, and combinations thereof. In a specific aspect, the binder can be polyvinylidene fluoride (PVDF), polyvinylidene fluoride-co-hexafluoropropylene (PVDF-HFP), polytetrafluoroethylene, carboxymethyl cellulose, alginate, or a combination thereof. Other suitable binders can also be used.

In some aspects, a conductive carbon (e.g., acetylene carbon, carbon black, graphite, graphene, or a combination thereof) can be included in the slurry and thus in the final cathode.

When present, the binder can be included in an amount of 1 to 20 weight percent, or 1 to 10 weight percent, or 2 to 8 weight percent, or 3 to 4 weight percent, each based on the total weight of the cathode active material, the binder, and the conductive carbon (when present). The conductive carbon can be present in an amount of 1 to 20 weight percent, or 1 to 10 weight percent, or 2 to 8 weight percent, or 3 to 4 weight percent, each based on the total weight of the cathode active material, the binder (when present), and the conductive carbon.

The anode can comprise graphite, activated carbon, hard carbon, carbon nanotubes, graphene, alkali metal foil (e.g., lithium foil), silicon, or a combination thereof

The electrochemical cell can further comprise an electrolyte. In an aspect, the electrolyte can include an alkali metal salt (e.g., a lithium salt, a sodium salt, or a potassium salt) and a solvent. Exemplary salts can include, for example, lithium or sodium salts bearing non-coordinating or weakly coordinating anions, including hexafluorophosphate (PF₆⁻), perchlorate (ClO₄⁻) , tetrafluoroborate (BF₄⁻) , bis(fluorosulfonyl)imide (FSI⁻) , or bis(trifluoromethanesulfonyl)imide (TFSI⁻) , among others. In a specific aspect, the alkali metal salt can be an alkali metal hexafluorophosphate salt.

The solvent can preferably be a nonaqueous solvent, and can comprise, for example, a carbonate solvent such as ethylene carbonate, ethyl methyl carbonate, or a combination thereof. In some aspects, the solvent can comprise an organic ether including but not limited to diglyme. The alkali metal salt can be present at any suitable concentration in the solvent. In some aspects, the alkali metal salt can be present in a concentration of 0.1 to 5 M, for example 0.5 to 2 M, or 0.9 to 1.1 M, or about 1 M.

This disclosure is further illustrated by the following examples, which are non-limiting.

### EXAMPLES

### Early Nucleation Enabled by Metal Precursors

The metal-precursor approach simplifies synthesis relative to oxide-based and co-precipitation routes by reducing unit operations, maintaining a comparable or lower thermal budget, eliminating solution effluents, and enabling the use of commodity metals. These process-level advantages are accompanied by a distinct reaction energy landscape that is established prior to calcination and ultimately governs both crystallization behavior and electrochemical properties.

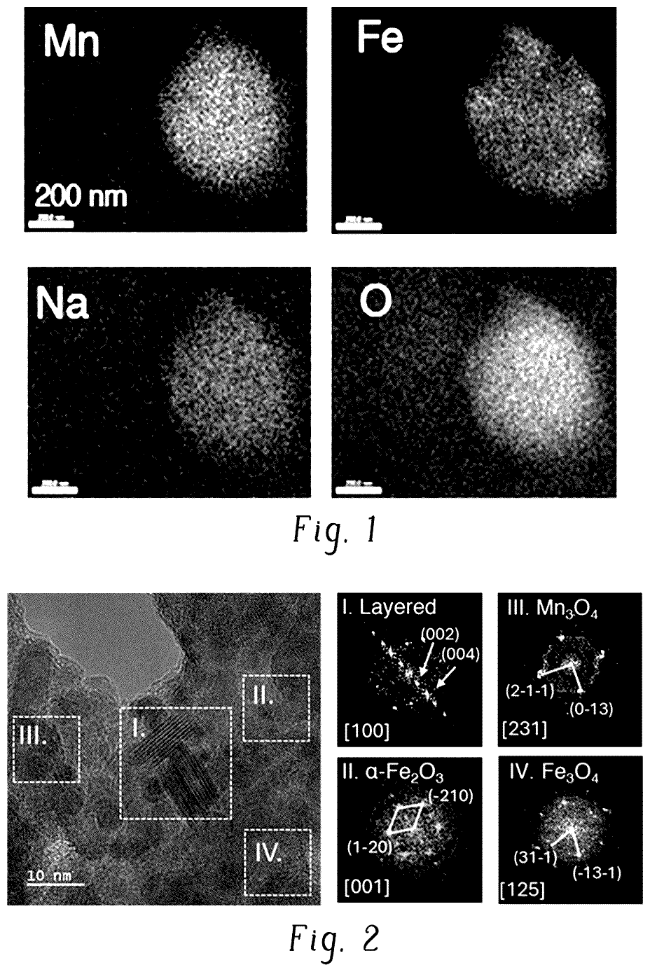

After high-energy ball-milling of metals and Na₂CO₃, energy-dispersive X-ray spectroscopy (EDS) maps show that Fe, Mn, Na and O are co-located within individual micron-scale particles in the FM13-M mixture (FIG. 1). Rather than remaining as discrete metal and salt particles, the constituents form an intimate composite, establishing short diffusion lengths and chemically coupled reaction interfaces prior to calcination.

Transmission electron microscopy (TEM) of the as-milled FM13-M precursor confirms that this composite contains multiple crystalline and disordered motifs before any heat treatment (FIG. 2). Fast Fourier transforms (FFT) of selected regions identify metallic α-Fe, α-Mn and oxidized phases such as Fe₃O₄ and Mn₃O₄, as well as nanoscale domains exhibiting layered diffraction signatures. The crystal structures of the metallic α-Fe, α-Mn phases are consistent with the corresponding metal precursors. The coexistence of metals, simple oxides and nascent layered regions within the same particle, as detected by TEM, is consistent with partial metal oxidation and early-stage layered oxide nucleation occurring during ball milling. In contrast, oxide-start mixtures typically form layered Na-TMO₂ only after prolonged equilibration at elevated temperatures. The O K-edge spectrum of the milled FM13-M powder shows a pre-edge feature near 529 eV associated with TM 3d-O 2p hybridization and a higher-energy feature near 532 eV associated with Na—O-TM coordination environments, consistent with the emergence of local oxygen coordination during milling.

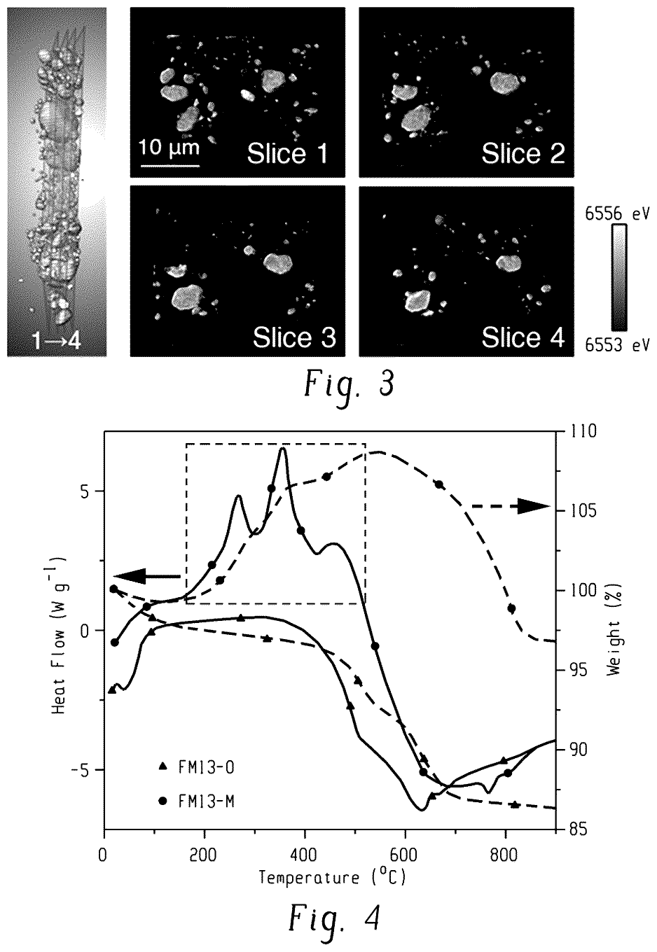

Two-dimensional (2D) transmission X-ray microscopy (TXM) at the Mn K-edge further reveals modest variations in the local edge position (E_{0.5}) across individual particles (FIG. 3). The edge energies fall between those of Mn metal and fully oxidized Mn oxides, consistent with local partial oxidation of Mn and wide oxidation state distribution during milling.

Thermal analysis reveals a distinct reaction sequence for the metal-start mixture. Differential scanning calorimetry (DSC) records discrete exothermic events that coincide with mass changes in thermogravimetric analysis (TGA, FIG. 4). For ball-milled Na₂CO₃ with Fe and Mn metals, three exothermic peaks are observed at 266, 354, and 454° C. A mass balance analysis based on Na_{0.7}Fe_{0.25}Mn_{0.75}O₂ shows the first event consistent with oxidation of Fe to FeO, corresponding to an expected mass increase of ~4%, in good agreement with the measured TG step. For the second peak, complete oxidation of both Fe and Mn to FeO and MnO without involvement of Na₂CO₃ would yield a cumulative mass increase of ~17.3%, whereas the measured increase after this event is only ~7%. This gap implies that Na₂CO₃ participates in the reaction at this stage, forming sodiated Na-TM-O phases with CO₂ release. The onset of fast sodiation therefore occurs near 354° C. corresponding to the second exothermic peak. In contrast, an oxide-start control, composed of ball-milled Na₂CO₃ with Fe₂O₃ and Mn₂O₃, exhibits two endothermic events near 500 and 630° C., placing the onset of sodiation at substantially higher temperatures.

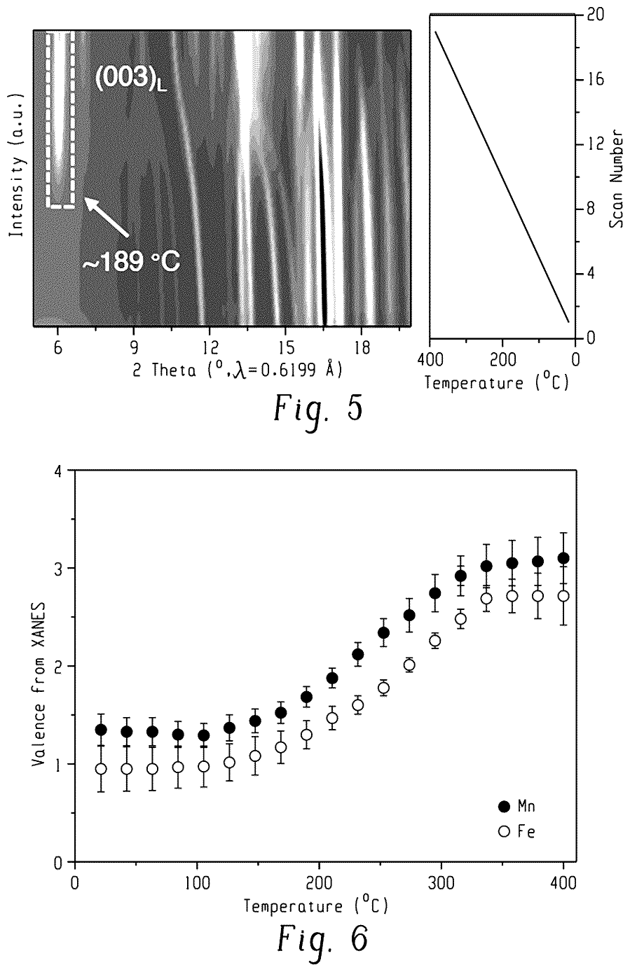

In-situ synchrotron X-ray diffraction (XRD) during heating shows that layered ordering emerges well before conventional sodiation temperatures. A low-angle layered peak within the white dashed box, indexed as the (003)_{L} of a Na-layered oxide corresponding to P3 phase, appears at 189° C. and increases steadily in intensity upon heating to 400° C. (FIG. 5). The gradual sharpening of this peak with temperature indicates progressive coarsening of layered domains rather than a delayed, abrupt phase transformation at ~400° C., as typically observed for oxide-start mixtures. Concurrently, temperature-dependent X-ray absorption near-edge structure (XANES) spectra analysis shows a continuous increase in the average Mn valence toward values between 3+and 4+, and Fe toward 3+, over the same temperature window (FIG. 6). Upon further heating to 800° C., in-situ XRD shows the emergence of an O3-type layered phase, which subsequently transforms into a P3 framework during continued heating. Meanwhile, in-situ XANES confirms rapid oxidation of both Fe and Mn, with final oxidation states converging to Mn between 3+ and 4+ and Fe at 3+ by the end of the heating sequence.

These multimodal observations indicate that nucleation and early growth of layered Na-TMO₂ take place during the initial stages of calcination in the metallic precursor route, with the major (003) peak of layered phase detectable by XRD as early as 189° C. This behavior is attributed to localized reaction acceleration driven by the exothermic oxidation of metallic components within dense metal-salt composites. This process generates heterogeneous intermediate phases and reaction fronts that promote early sodiation and layered ordering prior to global thermal equilibration. This pathway-dependent nucleation contrasts with diffusion-limited oxide-start synthesis and establishes the foundation for subsequent growth of layered frameworks. Notably, the accelerated nucleation is enabled not only by the TM-oxygen environments pre-established during ball milling but is further promoted by heat generated during metal oxidation. These two effects together lower the kinetic barrier for layered phase formation.

### Formation of Ordered Layered Cathodes

Soft X-ray absorption (XAS) at the Mn L-edge shows the as-milled metal-start sample (FM13-M-BM) already exhibits features characteristic of an oxidized surface, consistent with initial metal oxidation occurring during milling (FIG. 7). After calcination at 900° C. for 12 h, the Mn L-edge spectrum of FM13-M-900 shifts to higher energy and displays line shapes intermediate between Mn³⁺ and Mn⁴⁺ reference standards, indicating an average Mn oxidation state between 3+ and 4+, with Fe exhibiting a 3+ valence, as expected for Na_{0.7}Fe_{0.25}Mn_{0.75}O₂. For both metal- and oxide-derived precursors, reaching the equilibrium P2 phase requires sufficient thermal treatment to enable coupled Mn redox equilibration and Na rearrangement within the layered framework.

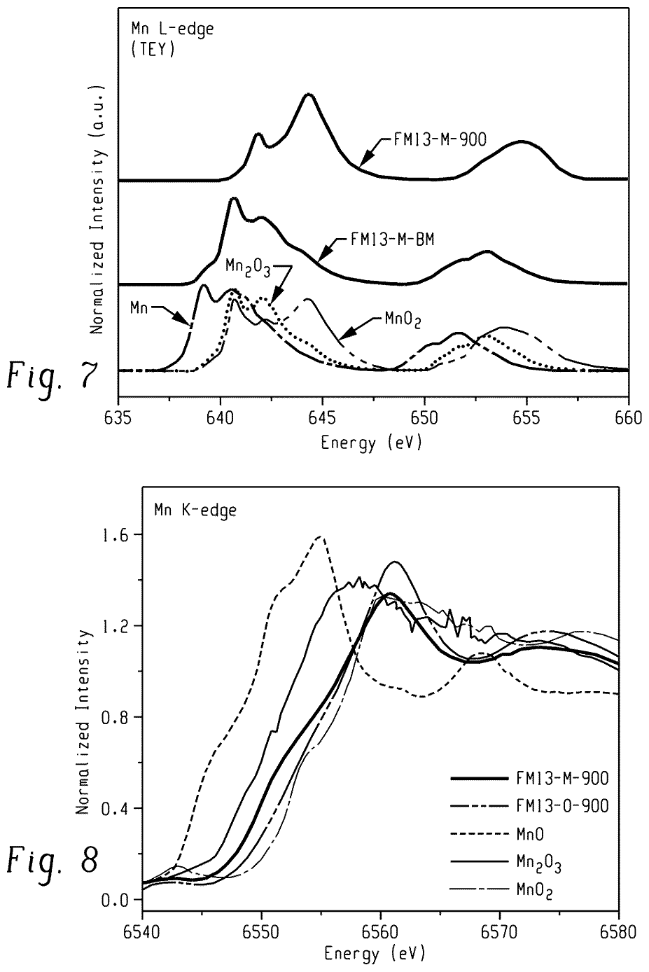

Mn K-edge XANES measured by hard XAS further highlights differences between metal-derived and oxide-derived products (FIG. 8). The Mn K-edge absorption edge of FM13-M-900 is shifted to lower energy relative to the oxide-start sample (FM13-O-900), indicating a lower average Mn oxidation state. Because the TM composition is fixed, this shift reflects greater charge compensation by alkali incorporation during crystallization, consistent with early sodiation observed for the metal-start route. In contrast to oxide-start processing, where prolonged high-temperature equilibration promotes TM over-oxidation, the metal route enables more alkali incorporation to the layered phase.

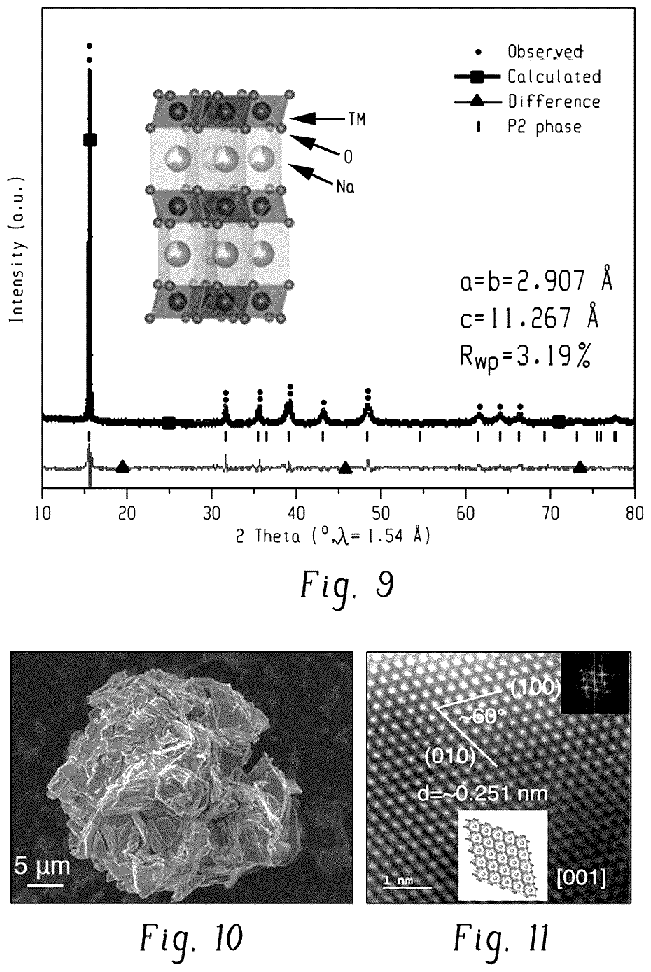

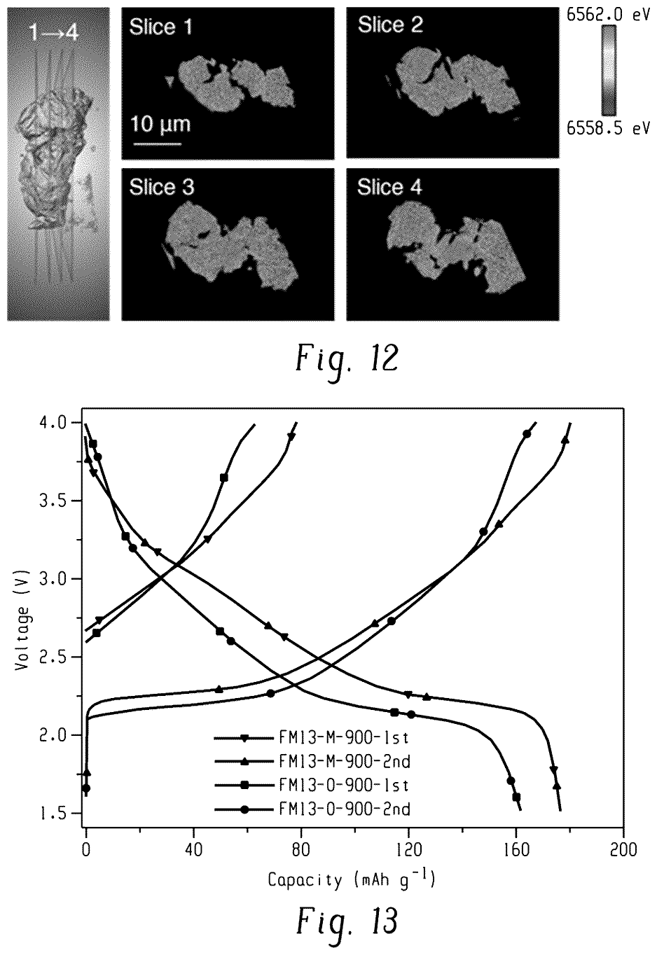

Powder XRD confirms that FM13-M-900 adopts a dominant P2-type layered framework (FIG. 9). In addition, FM13-M-900 shows a slightly larger lattice parameter c, which is beneficial for fast Na ion transport during electrochemical processes. Scanning electron microscopy (SEM) reveals clear differences in particle morphology between the two routes. FM13-M-900 consists of dense secondary particles with a shale-like laminated texture (FIG. 10). High-resolution TEM (HRTEM) images taken along the [001] zone axis show well-defined in-plane lattice fringes with a spacing of approximately 0.251 nm and a regular 60° angular relationship between symmetry-equivalent directions, consistent with a P2-type layered framework (FIG. 11). In contrast, FM13-O-900 synthesized from oxide precursors formed well-defined but thinner plate-like crystals that are less consolidated into secondary particles. As a result of these morphological differences, FM13-M-900 exhibits a higher packing density than FM13-O-900, while both samples retain a dominant P2 layered structure. Furthermore, three-dimensional (3D) TXM-XANES mapping of the Mn K-edge position within a single FM13-M-900 secondary particle reveals a relatively homogeneous valence distribution (FIG. 12).

### Robust Electrochemical Properties

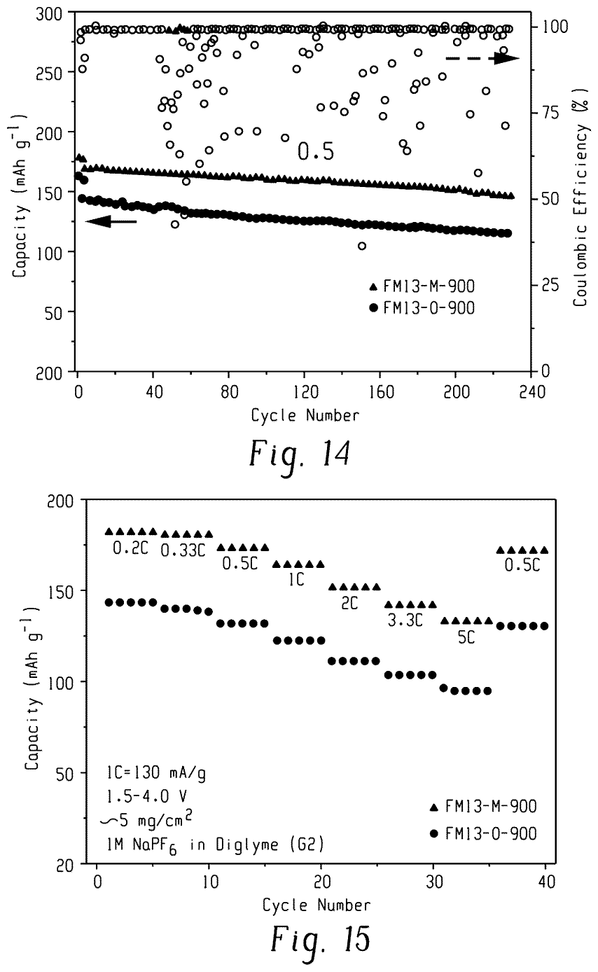

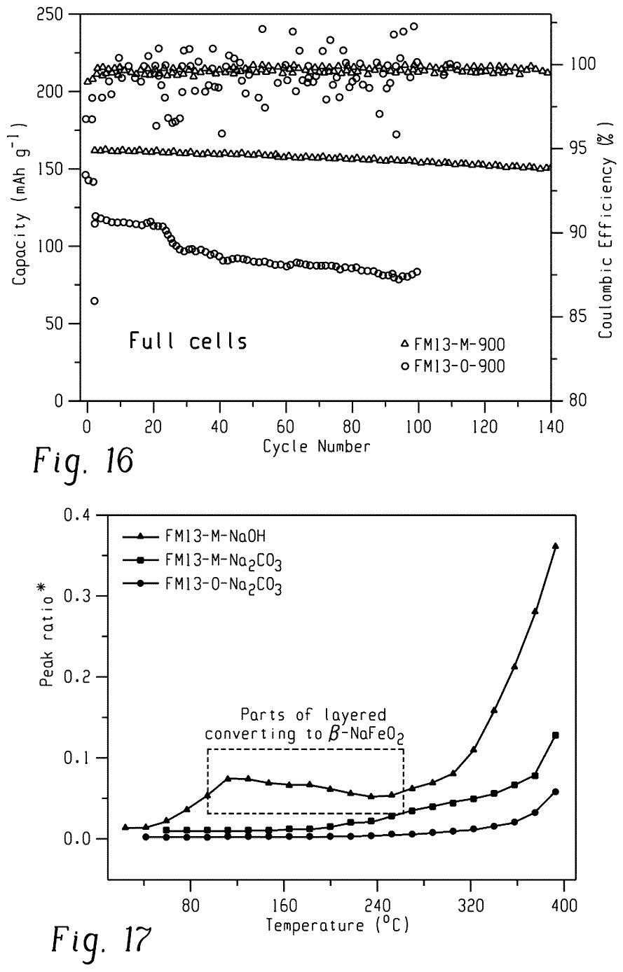

Electrochemical testing of FM13-M-900 demonstrates improved electrochemical properties compared with FM13-O-900. As shown in FIG. 13, FM13-M-900 delivers a higher capacity of 177 mAh g⁻¹ within the voltage range of 1.5-4.0 V at 0.1 C, and distinct redox behavior during charging and discharging processes, with FM13-M-900 maintaining a higher average discharge voltage and a smaller charge-discharge hysteresis. Notably, FM13-M-900 exhibits a higher first-charge capacity than FM13-O-900, consistent with a higher Na inventory retained after calcination and thus a larger amount of extractable Na from the as-synthesized P2 framework. The metal-derived P2 cathodes deliver higher reversible capacity and better capacity retention than oxide-derived analogues under identical cycling conditions, as shown in FIG. 14. FM 13-M-900 retains 89% of its capacity after 200 cycles, compared with 79% for FM 13-O-900. Moreover, FM 13-M-900 shows superior rate capability. When cycled at 5 C (1 C=130 mA g⁻¹), FM13-M-900 remains ~144 mAh g⁻¹, compared with ~90 mAh g⁻¹ for FM13-O-900. Note that the battery performance of the oxide-start material is comparable with or better than the literature values reported using similar oxide-start synthesis methods. These advantages are further reflected in full cells paired with hard carbon and operated at a high cathode active material mass loading of ~8.5 mg cm⁻², as shown in FIG. 16. FM13-M-900 still has a high initial capacity of 183 mAh g⁻¹ at 0.1 C, and better retention of 93% after 140 cycles.

Post-mortem synchrotron XRD analysis was performed on cycled electrodes to understand sodium ion retention in cathode active materials. The XRD patterns show that the cycled FM13-M-900 exhibits a stronger P2 (002) peak intensity. Meanwhile, its lattice parameter c became lower after long cycling, showing more Na active sites were retained for Na extraction and intercalation. In contrast, FM13-O-900 exhibits an attenuated (002) peak with increased lattice parameter c, suggesting reduced active Na sites compared with its pristine state. This observation is consistent with the higher capacity retention of FM13-M-900.

### Low-Temperature Synthesis and Extension to Other Cathode Chemistries

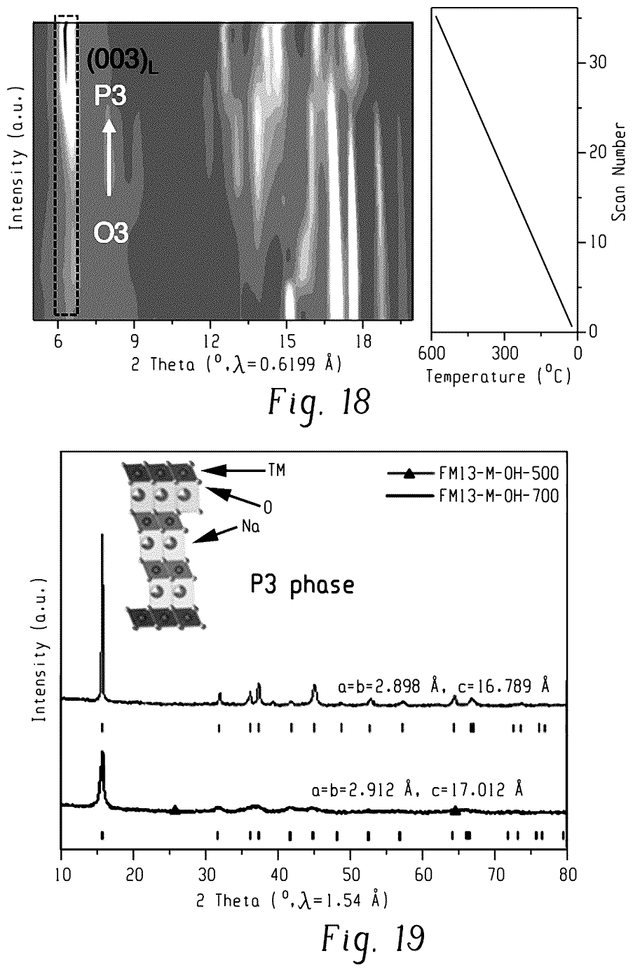

To examine whether the same reaction-pathway effects persist at lower temperatures and with alternative Na precursors, analogous compositions from metal precursors combined with either NaOH or Na₂CO₃ were synthesized and compared with an oxide-precursor control. NaOH was selected because of its lower melting point, which facilitates earlier solid-liquid interaction during heating. Following high-energy ball milling, the sample prepared from metals and NaOH exhibits a markedly stronger low-angle layered peak than its Na₂CO₃ counterpart, as well as greater TM oxidation, collectively indicating more extensive formation of layered motifs under otherwise identical processing conditions. To compare the extent of layered framework development across synthesis routes, the area ratio of the strongest layered (P3-type) (003) peak was compared to the strongest peak of the residual metal or oxide precursor, with low-angle regions of each case. FM13-M-Na₂CO₃ has a higher ratio than FM13-O-Na₂CO₃ at a given temperature (FIG. 17). Notably, this ratio is even higher for FM13-M-NaOH, demonstrating that using a low-melting Na salt further facilitates conversion of metal-start mixtures to layered P3 structures, leaving fewer residual metallic or oxide phases. In-situ XRD of FM13-M-NaOH shows the progressive growth and sharpening of P3 peaks upon heating (FIG. 18), again starting at temperatures substantially below those used in conventional solid-state synthesis. With NaOH as Na source, layered features appear during mechanochemical milling and the phase evolution proceeds from to an O3 layered structure first, followed by converting to P3 frameworks by ~618° C.. This sequence indicates that the metal-start pathway, combined with the low melting point of NaOH, enables early sodiation and layered ordering under reduced thermal budgets.

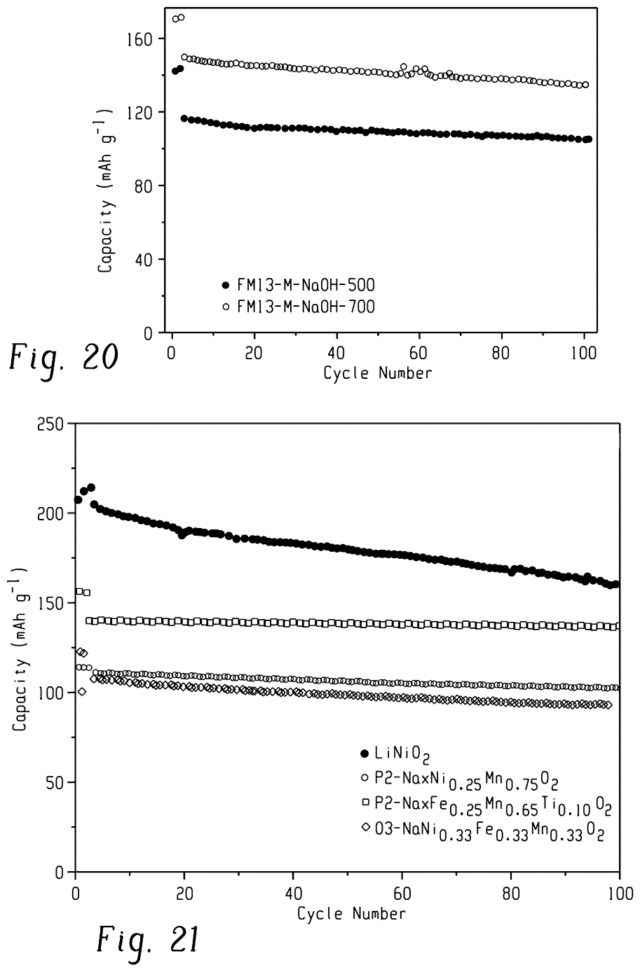

Ex situ XRD of FM13-M-NaOH calcined at 500° C. and 700° C. confirms the formation of layered P3-type phases at these relatively low temperatures (FIG. 19). XANES analysis shows that Mn and Fe reach high oxidation states (Mn approaching 4+ and Fe near 3+) at these temperatures, while SEM imaging reveals dense morphologies with increasing crystallinity as the calcination temperature is raised. Despite the reduced calcination temperatures, P3-type cathodes synthesized via the metal-start route with NaOH exhibit competitive electrochemical properties (FIG. 20), delivering initial discharge capacities of 170 mAh g⁻¹ and 145 mAh g⁻¹ for samples synthesized at 700° C. and 500° C., respectively. From a manufacturing perspective, the ability to access electrochemically active layered Na-TMO₂ phases at 500-700° C. using a simple, all-solid-state process highlights the generality of the metal-accelerated reaction pathway and suggests opportunities to lower energy consumption and shorten furnace residence times relative to conventional oxide-start routes.

The generality of the metal-precursor reaction pathway was further explored beyond the Na—Fe—Mn system, applying the same approach to multiple alkali-ion cathode chemistries spanning both sodium-and lithium-based frameworks. As a representative lithium cathode, lithium nickel oxide (LiNiO₂, LNO), a high-energy layered oxide of commercial relevance was selected. In-situ diffraction and XANES measurements reveal a smooth phase evolution from an initial cubic intermediate to a layered structure. Oxidation of Ni initiates near ~223° C., progresses toward NiO-like coordination by ~475° C., and is followed by the appearance of layered reflections near ~643° C., with rapid growth upon further heating to ~693° C. The final product is well indexed by an R^{3̅}m structure and exhibits coherent layered domains by TEM together with homogeneous elemental distributions by EDS. The metal-start route was then extended to a sodium layered oxide with a different transition-metal chemistry, O3-type NaNi_{1/3}Fe_{1/3}Mn_{1/3}O₂ (NFM). In-situ XRD shows that the metallic precursors convert to an observed layered ordering at ~168° C., followed by the emergence of layered features by ~550° C., with phase-pure O3 order obtained after a short hold near 800° C. (~44 min). XANES analysis indicates progressive oxidation of the transition metals during this sequence, with Mn oxidizing more readily than Fe and Ni. The final product is indexed as an R^{3̅}m layered phase and consists of submicrometer particles forming agglomerates.

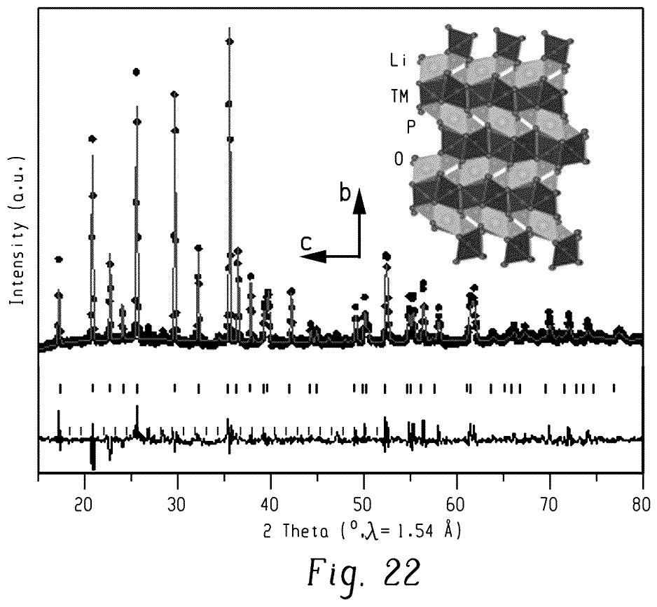

Across these Na- and Li-based layered cathodes, samples synthesized via the metal-start pathway consistently exhibit slower capacity fading and higher usable capacity at extended cycle numbers than oxide-derived counterparts processed at similar or higher temperatures (FIG. 21). These trends indicate that the benefits of the metal-precursor pathway are not restricted to a single composition or stacking type, but instead reflect a broader effect of pathway-dependent crystallization on electrochemical durability. Beyond layered oxides, applicability to a distinct intercalation framework was demonstrated by synthesizing LiFe_{0.6}Mn_{0.4}PO₄ (LFMP) from metallic precursors. Solid-state reaction of metals yields phase-pure olivine peaks in XRD with lattice parameters consistent with the LFMP structure (FIG. 22).

Taken together, these results demonstrate that metal-precursor synthesis alters the reaction pathway by which alkali-ion cathodes crystallize, rather than simply providing an alternative processing route. Intimate mixing of metals and alkali sources during milling, combined with exothermic metal oxidation during early heating, creates localized reaction fronts that enable layered nucleation at substantially lower furnace temperatures than conventional oxide-start synthesis. Continued oxidation during ramping then drives rapid growth of cathode active materials, yielding consolidated large particles. Compared with oxide-derived counterparts, the metal-derived cathodes exhibit a higher initial Na stoichiometry and improved electrochemical kinetics and durability. The extension of this pathway to lower-temperature processing and to multiple layered and polyanion chemistries underscores the generality of the approach.

Accordingly, the present disclosure transforms layered oxide synthesis from a prevailing precursor-engineering toward new pathway-engineering opportunities. By starting from metallic feedstocks, the reaction is driven by progressive oxidation rather than solely by diffusion-controlled equilibration of pre-oxidized precursors. The result is not simply a different route to the same average structure, but a distinct crystallization history that leaves measurable differences in materials properties. This pathway also promotes consolidation into compact particles with a high packing density without undermining electrochemical kinetics or durability. These results establish metal-precursor chemistry as a practical lever to couple simplified manufacturing with reaction-pathway control over cathode structure and electrochemical properties. More broadly, chemically reactive metallic feedstocks emerge as a new design axis for mixed metal oxide manufacturing.

Experimental details follow.

### Materials Synthesis

P2-type Na_{0.7}Fe_{0.25}Mn_{0.75}O₂ (FM13) was synthesized by solid-state reaction using either a metal-precursor route (Na₂CO₃ (Sigma-Aldrich, 99.95-100.05%), or NaOH (Sigma-Aldrich, 97%), Fe (ArtMolds) and Mn (Thermo Scientific Chemicals, 99.3%)) or an oxide-precursor route (Na₂CO₃, Fe₂O₃ (Thermo Scientific Chemicals, 99.9%) and Mn₂O₃ (Thermo Scientific Chemicals, 98%). In all cases, a 5 mol % excess of Na salt was added to compensate for alkali volatilization. The starting powders were ball-milled together for 10 h at 400 rpm, pressed into pellets, and calcined in box furnace (Lindberg, model: BF51894C-1) in air at 500, 700, or 900° C. for 12 h, with a ramp rate of 5° C./min. After cooling to room temperature, the products were milled and transferred to an Ar-filled glovebox for electrode fabrication and characterization.

LiNiO₂ (LNO) was synthesized from Ni (BeanTown Chemical, 99.9%) and LiOH (Thermal Fisher, 98%) with a 5 mol % excess of Li salt, followed by calcination at 700° C. for 10 h in flowing oxygen at 0.5 L/min. P2-type NaₓFe_{0.25}Mn_{0.75}Ti_{0.10}O₂ (FMT) was prepared from Na₂CO₃, Fe, Mn, and Ti (BeanTown Chemical, 99.5%) and calcined at 900° C. for 12 h in air. P2-type NaₓNi_{0.25}Mn_{0.75}O₂ (NM13) was synthesized from Na₂CO₃, Ni, and Mn metals and calcined at 900° C. for 12 h in air. O3-type NaNi_{1/3}Fe_{1/3}Mn_{1/3}O₂ (NFM) was synthesized from Na₂CO₃, Ni, Fe, and Mn metals and calcined at 850° C. for 10 h in air.

LiFe_{0.6}Mn_{0.4}PO₄ (LFMP) was synthesized from Fe and Mn metals, LiOH, and P₂O₅ (Thermo Scientific Chemicals, 98%). The mixture was calcined at 700° C. in air, mixed with poly(vinylpyrrolidone), and subsequently annealed at 650° C. in flowing argon at 0.5 L/min.

### Materials Characterizations

Synchrotron X-ray diffraction (XRD) was collected using a PerkinElmer area detector at 7-BM (QAS) (NSLS-II, Brookhaven National Laboratory). For In-situ heating XRD, mixtures of metals with Li or Na salt were pressed into thin pellets and heated in a Linkam TS 1500 stage up to 800° C. at a control ramp rate of 20° C. min⁻¹ in dry air gas flow. XRD scans were continuously collected during heating, with each scan taking 30s. CeO₂ was used to calibrate the temperature scale by its standard lattice expansion. Two-dimensional XRD images from the detector were integrated and converted using PyFAI with appropriate masks on individual images. Phase fractions and lattice parameters were refined using GSAS-II and FullProf software. For ex-situ XRD, samples were measured at 28-ID-2 (NSLS-II, Brookhaven National Laboratory) and Brucker D8 (Material Characterization Lab, Virginia Tech).

Synchrotron X-ray absorption spectroscopy (XAS) was performed at beamline 7-BM (QAS) (NSLS-II, Brookhaven National Laboratory). For in-situ heating experiments, mixtures of metals with Li or Na salt were pressed into thin pellets and heated in a Linkam TS1500 stage up to 800° C. at a control ramp rate of 20° C. min⁻¹. Sequential Fe and Mn K-edge XAS spectra (30 s per scan) were collected continuously during heating. Hard XAS data were analyzed using Athena and Artemis. XANES-derived oxidation states were obtained by linear combination fitting of K-edge spectra.

Soft X-ray absorption spectroscopy was performed at beamline 8-2 at the Stanford Synchrotron Radiation Lightsource. The energy resolution was 0.2 eV with a 1 mm² beam spot. Measurements were conducted at room temperature under ultrahigh vacuum (~10⁻⁹ torr) using both total electron yield and fluorescence yield modes. Soft XAS spectra were analyzed using PyMca.

The XANES-3D transmission X-ray microscopy (TXM) was performed at beamline 18-ID (FXI) (Brookhaven National Laboratory). TXM datasets have been reconstructed by a scientific package, TXM_Sandbox. The segmentation, quantification and visualization of the TXM results were performed with dragonfly v.2022.2.

Morphology was examined using scanning electron microscopy (JEOL IT-500HR) at 5 kV. Transmission electron microscopy (TEM), high-angle annular dark-field scanning transmission electron microscopy (HAADF-STEM), was performed on JEOL JEM ARM200F NEOARM (Nanoscale Characterization and Fabrication Lab, Virginia Tech).

Thermogravimetric analysis was performed using a Discovery SDT 650 instrument at a ramp rate of 5° C. min⁻¹ under flowing O₂.

### Electrochemical Characterization

Composite cathodes were prepared by mixing calcined active material, acetylene carbon black, and poly(vinylidene fluoride) binder in N-methyl-2-pyrrolidone (mass ratio 90:5:5). The slurry was cast onto carbon-coated aluminum foil and dried under vacuum at 120° C. overnight. Circular electrodes (10 mm diameter) were punched and transferred to an Ar-filled glovebox, with mass loading of ~5 mg/cm² and ~8.5 mg/cm².

CR2032 coin cells were assembled using lithium or sodium metal (or presodiated hard carbon) as the anode, glass microfiber (Whatman GF/D) as the separator, and 70 μL electrolyte. For Li cells, the electrolyte was 1 M LiPF₆ in ethylene carbonate/ethyl methyl carbonate (3:7 v/v). For Na cells, the electrolyte was 1 M NaPF₆ in diglyme. Galvanostatic charge and discharge tests were carried out at the selected voltage range at 25° C. using a multichannel battery tester (Wuhan Land). Cycling was performed at 0.5 C. Rate capability was measured at 0.2, 0.33, 0.5, 1, 2, 3.3, and 5 C, where 1 C corresponds to 130 mA g⁻¹.

This disclosure further encompasses the following aspects.

Aspect 1: A solid-phase method for the manufacture of a cathode active material, the method comprising: combining a metallic feedstock comprising elemental metal particles with an alkali metal source to form a reaction mixture; heating the reaction mixture under conditions effective to induce oxidation of the metallic feedstock and provide a calcined mixture; and forming the cathode active material from the calcined mixture.

Aspect 2: The solid-phase method of aspect 1, wherein the metallic feedstock comprises wherein the metallic feedstock comprises iron, manganese, nickel, cobalt, titanium, chromium, copper, zinc, tungsten, aluminum, magnesium, zirconium, germanium, molybdenum, tin, niobium, lanthanum, tantalum, calcium, vanadium, or a combination thereof.

Aspect 3: The solid-phase method of aspect 1 or 2, wherein combining the metallic feedstock with the alkali metal source comprises mechanochemical mixing, preferably ball milling, planetary milling, or mixer milling.

Aspect 4: The solid-phase method of any of aspects 1 to 3, wherein the alkali metal source comprises an alkali metal carbonate, an alkali metal hydroxide, an alkali metal peroxide, or a combination thereof.

Aspect 5: The solid-phase method of any of aspects 1 to 4, wherein heating the reaction mixture is at a temperature of 400 to 900° C. and for a time of 12 hours or less.

Aspect 6: The solid-phase method of any of aspects 1 to 5, wherein forming the cathode active material comprises cooling the calcined mixture and optionally crushing the cooled calcined mixture to provide cathode active material particles.

Aspect 7: The solid-phase method of any of aspects 1 to 6, wherein the metallic feedstock comprises recycled or reclaimed metallic material.

Aspect 8: The solid-phase method of any of aspects 1 to 7, wherein the metallic feedstock comprises iron and manganese; or iron, manganese, and titanium; or nickel and manganese; or nickel, iron, and manganese.

Aspect 9: The solid-phase method of any of aspects 1 to 8, wherein onset alkali metal insertion occurs at a temperature of 500° C. or less.

Aspect 10: The solid-phase method of any of aspects 1 to 9, wherein the cathode active material is a layered cathode active material.

Aspect 11: The solid-phase method of any of aspects 1 to 10, wherein the cathode active material comprises a P2-type Na_{0.7}Fe_{0.25}Mn_{0.75}O₂ layered cathode active material; or a P2-type NaₓFe_{0.25}Mn_{0.75}Ti_{0.10}O₂ layered cathode active material; or a P2-type NaₓNi_{0.25}Mn_{0.75}O₂ layered cathode active material; or a lithium nickel oxide layered cathode active material; or an O3-type NaNi_{1/3}Fe_{1/3}Mn_{1/3}O₂ layered cathode active material; or a LiFe_{0.6}Mn_{0.4}PO₄ olivine-type cathode active material; wherein, in the foregoing formulas, 0 <x <1.

Aspect 12: A cathode active material made by the method of any of aspects 1 to 11.

Aspect 13: The cathode active material of aspect 12, wherein the cathode active material is an alkali-metal layered oxide.

Aspect 14: The cathode active material of aspect 12 or 13, wherein the cathode active material comprises an O3 type, a P2 type, or a P3 type layered framework.

Aspect 15: The cathode active material of aspect 12 or 13, wherein the cathode active material comprises an olivine-type structure.

Aspect 16: The cathode active material of any of aspects 12 to 15, wherein the cathode active material has a packing density that is at least 15% greater than a packing density of a corresponding cathode active material prepared from a metal oxide precursor.

Aspect 17: The cathode active material of any of aspects 12 to 16, wherein the cathode active material exhibits a capacity that is greater than that of a corresponding cathode active material prepared from a metal oxide precursor, determined at a voltage of 1.5-4.0 V and a rate of 0.1 C; and a capacity retention of at least 85%, or at least 90% after 100 cycles, or after 120 cycles, or after 140 cycles at a rate of 0.5 C.

Aspect 18: An electrochemical cell comprising a cathode active material made by the method of any of aspects 1 to 11.

Aspect 19: An electrochemical cell comprising: a cathode comprising a cathode active material made by the method of any of aspects 1 to 11; an anode; a separator disposed between the cathode and the anode; and optionally, an electrolyte.

Aspect 20: The electrochemical cell of aspect 19, wherein the electrochemical cell retains at least 85% of its discharge capacity after 100 cycles at 0.5 C.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A solid-phase method for the manufacture of a cathode active material, the method comprising:
combining a metallic feedstock comprising elemental metal particles with an alkali metal source to form a reaction mixture;
heating the reaction mixture under conditions effective to induce oxidation of the metallic feedstock and provide a calcined mixture; and
forming the cathode active material from the calcined mixture.

2. The solid-phase method of claim 1, wherein the metallic feedstock comprises iron, manganese, nickel, cobalt, titanium, chromium, copper, zinc, tungsten, aluminum, magnesium, zirconium, germanium, molybdenum, tin, niobium, lanthanum, tantalum, calcium, vanadium, or a combination thereof.

3. The solid-phase method of claim 1, wherein combining the metallic feedstock with the alkali metal source comprises mechanochemical mixing, preferably ball milling, planetary milling, or mixer milling.

4. The solid-phase method of claim 1, wherein the alkali metal source comprises an alkali metal carbonate, an alkali metal hydroxide, an alkali metal peroxide, or a combination thereof.

5. The solid-phase method of claim 1, wherein heating the reaction mixture is at a temperature of 400 to 900° C. and for a time of 12 hours or less.

6. The solid-phase method of claim 1, wherein forming the cathode active material comprises cooling the calcined mixture and optionally crushing the cooled calcined mixture to provide cathode active material particles.

7. The solid-phase method of claim 1, wherein the metallic feedstock comprises recycled or reclaimed metallic material.

8. The solid-phase method of claim 1, wherein the metallic feedstock comprises iron and manganese; or
iron, manganese, and titanium; or
nickel and manganese; or
nickel, iron, and manganese.

9. The solid-phase method of claim 1, wherein onset alkali metal insertion occurs at a temperature of 500° C. or less.

10. The solid-phase method of claim 1, wherein the cathode active material is a layered cathode active material.

11. The solid-phase method of claim 1, wherein the cathode active material comprises
a P2-type Na_{0.7}Fe_{0.25}Mn_{0.75}O₂ layered cathode active material; or
a P2-type NaₓFe_{0.25}Mn_{0.75}Ti_{0.10}O₂ layered cathode active material; or
a P2-type NaₓNi_{0.25}Mn_{0.75}O₂ layered cathode active material; or
a lithium nickel oxide layered cathode active material; or
an O3-type NaNi_{1/3}Fe_{1/3}Mn_{1/3}O₂ layered cathode active material; or
a LiFe_{0.6}Mn_{0.4}PO₄ olivine-type cathode active material;
wherein, in the foregoing formulas, 0<x<1.

12. A cathode active material made by the method of claim 1.

13. The cathode active material of claim 12, wherein the cathode active material is an alkali-metal layered oxide.

14. The cathode active material of claim 12, wherein the cathode active material comprises an O3 type, a P2 type, or a P3 type layered framework.

15. The cathode active material of claim 12, wherein the cathode active material comprises an olivine-type structure.

16. The cathode active material of claim 12, wherein the cathode active material has a packing density that is at least 15% greater than a packing density of a corresponding cathode active material prepared from a metal oxide precursor.

17. The cathode active material of claim 12, wherein the cathode active material exhibits
a capacity that is greater than that of a corresponding cathode active material prepared from a metal oxide precursor, determined at a voltage of 1.5-4.0 V and a rate of 0.1 C; and
a capacity retention of at least 85%, or at least 90% after 100 cycles, or after 120 cycles, or after 140 cycles at a rate of 0.5 C.

18. An electrochemical cell comprising a cathode active material made by the method of claim 1.

19. An electrochemical cell comprising:
a cathode comprising a cathode active material made by the method of claim 1;
an anode;
a separator disposed between the cathode and the anode; and
optionally, an electrolyte.

20. The electrochemical cell of claim 19, wherein the electrochemical cell retains at least 85% of its discharge capacity after 100 cycles at 0.5 C.
